(19) United States
(12) Patent Application Publication
(10) Pub. No.: US 2018/0022455 A1
(43) Pub. Date: Jan. 25, 2018

(54) DROPPING MECHANISM WITH UNIVERSAL MOUNTING POINTS

(71) Applicant: Dustin McCaslin, Shafter, CA (US)

(72) Inventor: Dustin McCaslin, Shafter, CA (US)

(21) Appl. No.: 15/655,805

(22) Filed: Jul. 20, 2017

Related U.S. Application Data
(60) Provisional application No. 62/364,651, filed on Jul. 20, 2016.

(51) Int. Cl. B64D 1/12; B64C 39/02; B64D 47/08

(52) U.S. Cl. CPC B64D 1/12; B64D 47/08; B64C 39/024; B64C 2201/126; B64C 2201/128; B64C 2201/146; B64C 2201/027; B64C 2201/108; B64C 2201/165

(57) ABSTRACT

A dropping mechanism with universal mounting points includes a device for securing a payload to a drone, mechanically releasing it and mounting additional accessories that can be used during flight. The dropping mechanism can be attached to either the landing gear or body of the drone, in an orientation that allows contact between the release trigger and the drone's camera. A notch and groove system holds a sliding restraint in place, keeping the payload secure during flight. Once the release trigger is pushed, an energized member pulls the sliding restraint allowing the payload to drop. Since the camera is pointed down to actuate the trigger, the user can watch as the payload falls to the ground. The use of a mechanical dropping system makes this device compatible with drones that only have an electrical connection for the camera. Universal mounting points allow attachment of a wide variety of accessories.

### RELATED APPLICATION

This application claims the benefit of priority to the United States Provisional Patent Application for “DROPPING MECHANISM WITH UNIVERSAL MOUNTING POINTS”, Application No. 62/364,651 filed on Jul. 20, 2016.

### FIELD OF THE INVENTION

The present invention pertains generally to a camera actuated mechanical release device used in conjunction with remote controlled drones. More specifically, the present invention pertains to a latching device capable of being attached to a drone that allows the user to carry a payload and by moving the camera to a pre-determined position, drop the carried payload. The present invention is particularly, but not exclusively, useful as a convenient way to carry objects with a drone, fly them to a desired location, and release them when they are over the intended drop zone. The base plate for the dropping device can be configured to attach to the landing gear of different drones and configured to carry payloads of different weights. The base plate also has additional attachment points that allow the user to further accessorize their drone.

### BACKGROUND OF THE INVENTION

Piloting remote-control drones has become a popular hobby in this modern era with drones that are often used in photography, racing and general recreation. A typical drone has four motor driven propellers that are evenly spaced for stability during flight. The motors are controlled by an encapsulated control unit that receives radio frequency signals from a transmitter. To pilot a drone the user can either use a radio control system or a smart device such as a phone or a tablet that transmits signals wirelessly. A battery is connected to the control unit to power the motors and the electronics attached to the drone. Some drones also have cameras capable of taking pictures, videos or relaying the sight of the camera back to the user.

Currently, accessorizing a drone is not easy or user friendly. Typically, there are no additional accessory control electronics connections so most accessories attach to the connector that powers the camera, requiring the user to fully disconnect and dismount the camera and mount the accessory in the cameras place. With the new accessory attached, the user is unable to take pictures, video, or even fly the drone through the camera image relayed to the user. Other than the connection port for the battery and camera, additional connection ports to the drone control unit for accessories are scarce.

Dropping objects from drones is both fun to watch and a convenient way to deliver packages. However, most drones cannot attach a dropping system without removing the camera. By removing the camera attached to the drone, the user is unable to see the surrounding environment through the eyes of the drone. A user flying a drone from a remote location cannot watch the payload as it is being dropped from the drone without the aid of the camera. Not watching the dropped object, can result in a poorly dropped payload, since the user cannot view the intended drop area. Also, gently placing fragile packages down becomes almost impossible. By removing the perspective of the drone, the user cannot enjoy the drop of the payload from the altitude that it was released, nor can a more careful delivery be made.

To add additional electronic accessories, the user often needs to modify the control unit of the drone. These modifications to the control unit can be costly and time consuming. Most modifications to a drone, done by the user, void the factory warranty that comes with the drone. Due to the lack of accessories, most users are creating their own electronics packages to control the accessories that they want. Also, due to the lack of mounting options on factory drones, poorly attached user created accessories can detach from the drone during flight and fall from the altitude of the drone, most likely causing damage or injury.

Therefore, it would be advantageous to have a mechanical dropping mechanism that requires no modification of an existing drone. It would also be advantageous for the mount carrying the mechanical dropping mechanism to provide additional mounting space that could securely carry additional drone accessories without modification to the drone itself.

### SUMMARY OF THE INVENTION

Most commercially available drones have a control unit, flight motors, landing gear and usually a camera. A user can fly the drone by sending radio frequency signals to the control unit to drive the flight motors. The user can also dynamically control the camera attached to the drone to rotate to allow the user to see the surroundings of the drone from the drone's perspective. When the drone is finished flying, it can be set back down on the landing gear to prevent damage to the drone.

The Dropping Mechanism with Universal Mounting Points, of the present invention also referred to as the “Dropping Mechanism” is capable of being mounted to the landing gear of a drone, allowing the user to carry a payload to a desired location, drop the payload with a mechanically operated release and securely transport additional accessories mounted to the base plate.

The Dropping Mechanism of the present invention has five primary components: a base plate, a sliding restraint, a release trigger, a mechanism housing, and an energized member.

The base plate is formed with a plurality of attachment points for additional accessories along with mounting slots positioned for connecting to a drone. The attachment points are identical and evenly spaced and allow easy mounting of accessories in the orientation that best fits the user's needs. Common accessories include flashlights for night flights, flight recorders and additional image capturing modules. The mounting slots that connect the Dropping Mechanism to the drone can be configured to connect to the various different designs of drone landing gear or drone bodies available in the marketplace. While the drone shown in the attached figures is a DJI® Phantom, any drone capable of lifting a payload known to those skilled in the art, may connect a Dropping Mechanism to a part of its structure for use.

The base plate is also formed with a base plate aperture. As set forth further below, the base plate aperture works in combination with a retaining pin in the sliding restraint to secure a payload hook or payload strap connected to a payload.

The sliding restraint has a retaining pin, retention groove formed within a retention tab, and a sliding restraint stop. The retaining pin secures a payload strap or payload hook within the base plate aperture until it is dropped by the user through use of the drone's camera. The edge of the retaining pin may be sloped to aid in release of the payload. The sliding restraint stop comes into contact with the release trigger to stop the closing movement of the sliding restraint. When the sliding restraint is in the drop position, the sliding restraint stop prevents the release trigger from over travel due to excess force imparted by the drone's camera. The sliding restraint has depressions in the form of retention groove shaped to accept the release trigger notch. An energized member acts on the sliding restraint and moves the sliding restraint from the secured position to the drop position.

In one embodiment, the energized member is an elastic strap, such as a rubber band. The elastic strap is attached to a power end of the sliding restraint and to a tension screw connected to the base plate. The tension screw can be threadably inserted into various positions on the base plate to allow the user to adjust the opening force on the sliding restraint.

The position of the tension screw on the base plate can be changed depending on the user's needs. Also, the type and number of elastic straps can be changed to fit the user's needs. The elastic strap is connected to the tension screw in the base plate and also connected to the retaining pin of the sliding restraint. The elastic strap provides the force needed to pull the sliding restraint sufficiently to for the retaining pin to clear the base plate aperture and the mechanism housing aperture when the user wants to release the payload. It is to be appreciated by those of skill in the art that an elastic strap or any stretchable object with a high enough spring constant to move the sliding restraint, could be used.

As an alternative, the energized member may be a spring housed within and between the mechanism housing and sliding restraint. A spring loading tab formed in the sliding restraint compresses and energizes the spring when the sliding restraint is manually moved from the drop position to the secured position.

The release trigger has a flat shoe that comes into contact with the drone's camera, a release trigger notch and a release trigger mounting hole. The release trigger notch fits into the retention groove and keeps the retaining pin in place until the payload needs to be released. To release the payload, the camera of the drone is directed straight down causing it to come into contact with the flat shoe of the release trigger. This force imparted on the flat shoe lifts the release trigger notch out of a retention groove, allowing the elastic strap to pull the sliding restraint from the secured position to the drop position.

The mechanism housing keeps the release trigger and sliding restraint in place by pressing them against the base plate. The mechanism housing mounts to the base plate with mounting retaining clips. The mechanism also contains a pin that protrudes through the release trigger and acts as a fulcrum when the release trigger is pushed by the drone's camera. The mechanism housing also has a mechanism housing aperture that is similar in size to the base plate aperture. The mechanism housing is connected to the base plate such that the mechanism housing aperture is approximately aligned with the base plate aperture. The inclusion of a mechanism housing aperture ensures sufficient clearance for the payload hook or payload strap placed around the retaining pin of the sliding restraint when in the secured position.

In use, a user first connects the Dropping Mechanism to the landing gear of a drone. Next, the user connects a payload to a payload hook or payload strap. The user then moves the sliding restraint from a drop position to a secured position. As the user moves the sliding restraint from the drop position to the secured position, the energizing member becomes energized. Also, as the user moves the sliding restraint from the drop position to the secured position, the user simply passes the retaining pin through the payload strap or payload hook until the sliding restraint is held in place by the release trigger notch secured within the retention groove in the sliding restraint. Once in the secured position, the payload strap or payload hook are secured around the retaining pin within the base plate aperture and the mechanism housing aperture. Once so secured, the user flies the drone to a desired altitude above a desired location. Finally, the user rotates the drone camera towards the ground and in so doing, the camera strikes the flat shoe of the release trigger, thereby releasing the release trigger from the sliding restraint. The sliding restraint then is moved from the secured position to the drop position by the energized member thereby enabling the payload hook or payload strap to freely pass from the base plate aperture and mechanism housing aperture, allowing the payload to drop to the ground. Finally, the user can view the payload fall to the desired location using the camera of the drone.

### BRIEF DESCRIPTION OF THE DRAWING

The nature, objects, and advantages of the present invention will become more apparent to those skilled in the art after considering the following detailed description in connection with the accompanying drawings, in which like reference numerals designate like parts throughout, and wherein:

FIG. 1 is a front view of the Dropping Mechanism, showing a drone with the Dropping Mechanism attached to its landing gear;

FIG. 2 is a top view of the Dropping Mechanism of the present invention, showing the baseplate with the release trigger notch of the release trigger holding the sliding restraint in the secured position against the tension of the elastic strap, before the flat shoe is depressed, which causes the release trigger to pivot around the mechanism housing pin of the mechanism housing allowing the sliding restraint to move, the GoPro® Mount is also shown;

FIG. 3 is a top view of the Dropping Mechanism of the present invention, showing the base plate with the sliding restraint in its drop position and the release trigger notch not holding the sliding restraint in place after the flat shoe was depressed, allowing the sliding restraint to move in the direction of the tension of the elastic strap under the mechanism housing, the GoPro® Mount is also shown;

FIG. 4 is a detailed view of the Dropping Mechanism, showing the release trigger positioned against the sliding restraint in the secured position;

FIG. 5 is a detailed view of the Dropping Mechanism, showing the release trigger releasing the sliding restraint which has moved to the drop position;

FIG. 6 is a detailed view of the Dropping Mechanism, showing the top and bottom of the release trigger with the sliding restraint in the drop position;

FIG. 7 is a top view of the base plate of the Dropping Mechanism, showing the base plate formed with mounting notches and a plurality of evenly spaced attachment points;

FIG. 8 is a top view of the sliding restraint of the Dropping Mechanism, showing the positioning of the sliding restraint stop, retaining pin, and retention groove;

FIG. 9 is a top view of the release trigger of the Dropping Mechanism, showing the flat shoe, release trigger notch and release trigger mounting hole;

FIG. 10 is a perspective view of the mechanism housing of the Dropping Mechanism, showing the mechanism housing formed with mechanism housing pin, a mechanism housing aperture and mounting retaining clips;

FIG. 11 is an exploded view of the Dropping Mechanism, showing the mechanism housing, release trigger, sliding restraint, and base plate;

FIG. 12 is a bottom view of the Dropping Mechanism, mounted to the landing gear of an exemplary drone, and showing the relative positioning of the release trigger and the drone camera, the camera rotating toward the release trigger, and showing the sliding restraint in the closed position;

FIG. 13 is a perspective view of the Dropping Mechanism attached to the landing gear of a drone with the sliding restraint in the drop position as a result of the camera of the drone striking the flat shoe of the release trigger;

FIG. 14 is a perspective view of the GoPro® mount, showing the GoPro® mount attached to the base plate;

FIG. 15 is a perspective view of the Dropping Mechanism, showing a GoPro® mounted to the GoPro® mount attached to the base plate;

FIG. 16 is a side view of an embodiment of the base plate showing end channels sized to fit over landing gears of a drone, the end channels having retention notches sized to retain and secure a drone landing gear in the end channels;

FIG. 17 is an isometric view of the base plate shown in FIG. 16 and showing a plurality of attachment points along with a base plate aperture;

FIG. 18 is a rear view of an embodiment of the Dropping Mechanism in the closed position with the retaining pin enclosing the base plate aperture;

FIG. 19 is a front view of the Dropping Mechanism shown in FIG. 18 in the closed position with the retaining pin passed across the width of the base plate aperture and the mechanism housing aperture and with the mechanism housing aperture aligned with the base plate aperture;

FIG. 20 is a front view of the Dropping Mechanism shown in FIG. 19 in the drop position with the retaining pin no longer obstructing the base plate aperture and the mechanism housing aperture;

FIG. 21 is a rear isometric view of the mechanism housing of the Dropping Mechanism shown in FIG. 20, and showing an energized member made of a spring;

FIG. 22 is a rear isometric view of the sliding restraint of the Dropping Mechanism shown in FIG. 20, and showing a spring channel with a spring compression tab;

FIG. 23 is an isometric view of a strike plate extender having a series of strike plate grooves;

FIG. 24 is an isometric view of an embodiment of a trigger having a forked shoe sized to slidably fit in each of the strike plate grooves of the strike plate extender shown in FIG. 23; and

FIG. 25 is an assembled view of the strike plate extender shown in FIG. 23 slidably connected to the trigger shown in FIG. 24 thereby creating a larger striking surface for the camera of a drone.

### DETAILED DESCRIPTION OF A PREFERRED EMBODIMENT

The Dropping Mechanism with Universal Mounting Points is capable of being mounted to a drone, allowing the user to carry and drop a payload, as well as attach additional accessories in multiple orientations.

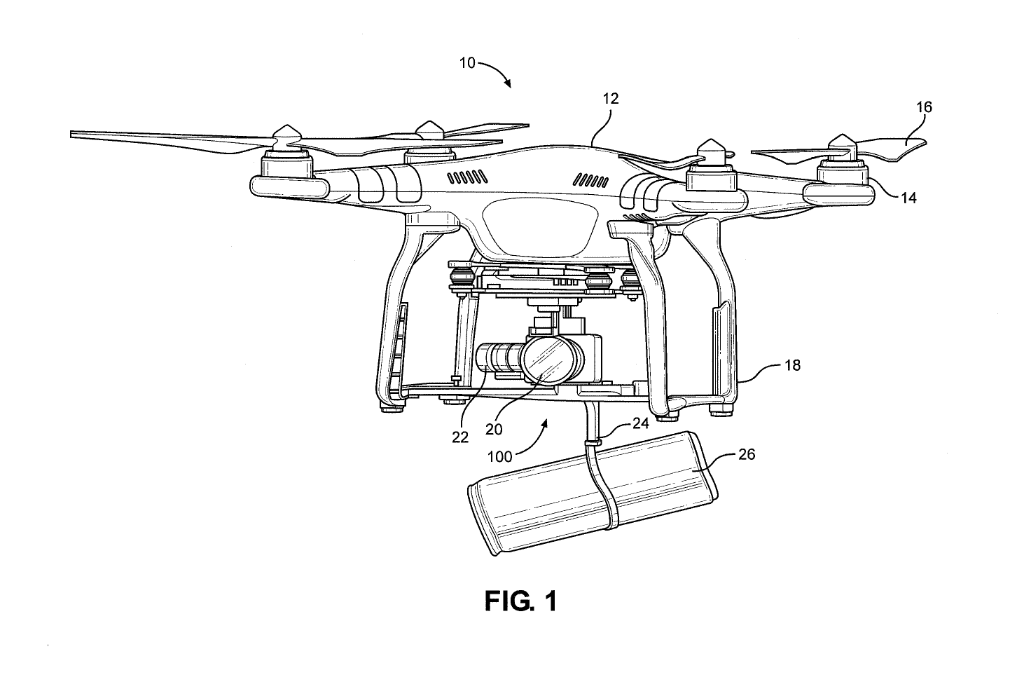

Referring initially to FIG. 1, the present invention is shown and generally designated 100. As depicted in FIG. 1, the Dropping Mechanism 100 of the present invention is attached to a drone 10 at the drone landing gear 18 of the drone 10 and is shown carrying a payload 26 fastened to the Dropping Mechanism 100 by a payload hook 24.

The drone 10 has a drone control unit 12 that receives radio frequency signals from a transmitter to power the flight motors 14, camera 20 and camera motor 22. The Dropping Mechanism 100 holds payload 26 as flight motors 14 propel rotating propellers 16, which in turn provide lift and thrust to the drone 10. The camera 20 is adjusted with camera motors 22 to enable a user to film and view the flight from the perspective of the drone 10.

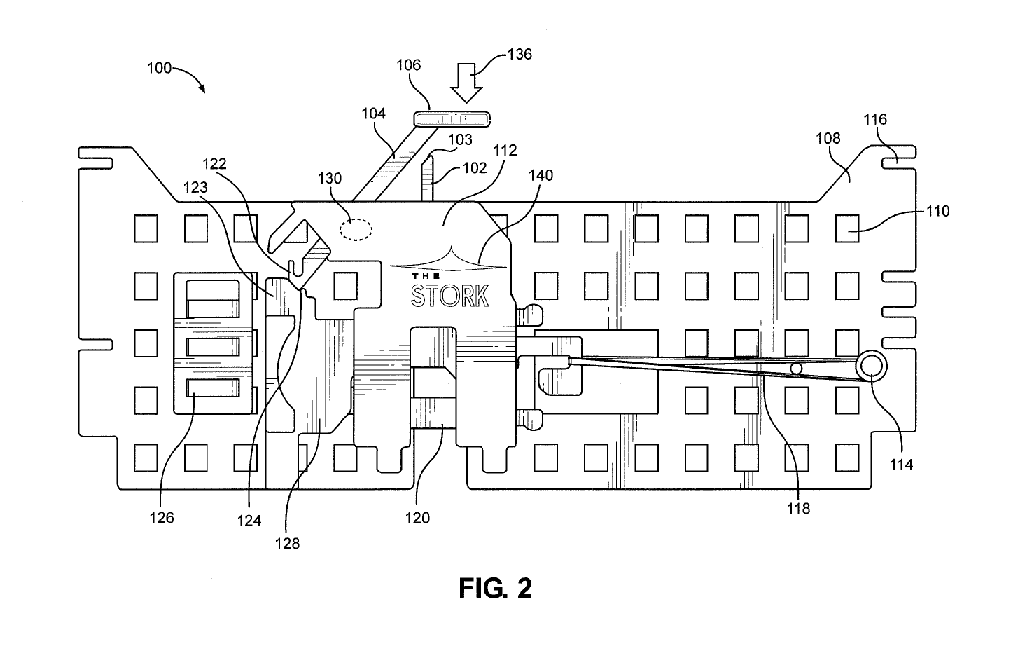

Once the payload 26 is over the intended drop zone, the flight motors 14 stabilize the drone 10 over the drop zone. A signal is then sent to the drone control unit 12 to actuate the camera motors 22 down in the direction of the release trigger 104 (not shown, as subsequently discussed in FIGS. 2-6, 9, 11-13), pushing the camera 20 into the flat shoe (not shown as subsequently discussed in FIGS. 2-6, 9, 11-13) of the release trigger (not shown, as subsequently discussed in FIGS. 2-6, 9, 11-13) of the Dropping Mechanism 100 causing the payload 26 to drop.

Since camera 20 has been actuated down by camera motors 22, the drone control unit 12 can transmit the image seen by camera 20 back to the user during the free fall of payload 26. Also, with the camera 20 in a position to view the release of the payload 26, it can be gently set down, which allows safe delivery of fragile payloads 26.

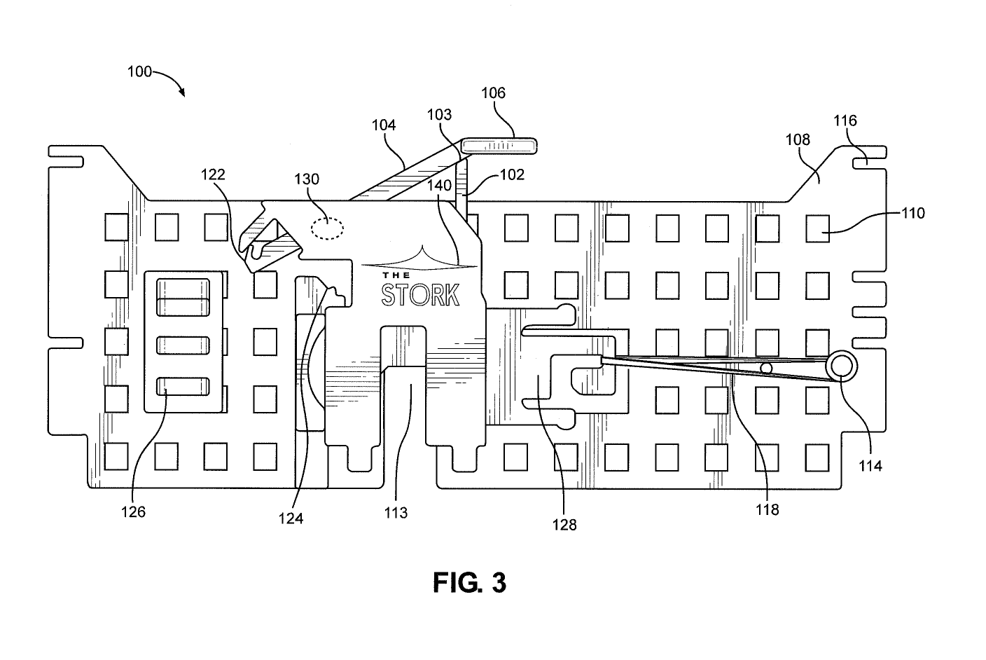

Referring next to FIG. 2 and FIG. 3, the Dropping Mechanism 100 of the present invention is shown in a secured position and a drop position respectively.

FIGS. 2 and 3 show sliding restraint stop 102, release trigger 104, flat shoe 106, base plate 108, attachment point 110, mechanism housing 112, tension screw 114, mounting notch 116, elastic strap 118, retaining pin 120, release trigger notch 122, retention groove 124, Go Pro® mount 126, and sliding restraint 128, mechanism housing pin 130 (shown as a dashed circle), and directional arrow 136. A logo 140 is placed on the front of the mechanism housing 112.

The Dropping Mechanism 100 has a base plate 108 with a mechanism housing 112 connected to the base plate 108. A sliding restraint 128 is slidably disposed between the base plate 108 and the mechanism housing 112. The sliding restraint 128 slides from the secured position to the drop position and vis a versa. In the secured position, the sliding restraint 128 has a retaining pin 120 that secures the payload hook 24 (shown in FIG. 1) when in the secured position and releases the payload hook 24 when in the drop position.

A release trigger 104 is rotatably connected to the mechanism housing 112. The release trigger 104 has a flat shoe 106 opposite a release trigger notch 122. In the secured position, the release trigger notch 122 is in contact with a retention groove 124 formed in the sliding restraint 128.

FIG. 2 shows sliding restraint 128 in the secured position with retaining pin 120 spanning the entire width of mechanism housing 112. Sliding restraint 128 is held in place by the spring force of elastic strap 118 that pulls release trigger notch 122 against retention groove 124. The elastic strap 118 is secured to the tension screw 114 and the sliding restraint 128. Directional arrow 136 shows the direction the flat shoe 106 of the release trigger 104 is hit to disengage release trigger notch 122 from retention groove 124. As flat shoe 106 is pressed, release trigger 104 rotates around mechanism housing pin 130 (shown in dashed lines). Mechanism housing pin 130 acts as a fulcrum for release trigger 104.

FIG. 3 shows sliding restraint 128 in the drop position with retaining pin 120 pulled into mechanism housing 112 by elastic strap 118 after flat shoe 106 is depressed in the direction of directional arrow 136. Release trigger notch 122 is no longer exerting force against a retention groove 124 of sliding restraint 128. Once Sliding restraint 128 is in its drop position, the payload 26 (not shown, see FIG. 1) is released from the Dropping Mechanism 100.

The mechanism housing 112 has a mechanism housing aperture 113. Similarly, the base plate 108 has a base plate aperture 115. In the embodiment disclosed in FIGS. 2-3, the mechanism housing 112 is connected to the base plate 108 such that the mechanism housing aperture 113 is aligned with the base plate aperture 115.

These apertures 113 and 115, coupled with the retaining pin 120 of the sliding restraint 128, retain the payload hook/payload strap 24 when the sliding restraint 128 is in the secured position. Similarly, the apertures 113 and 115 allow a clear path of travel of the payload hook/payload strap 24 from the Dropping Mechanism 100 when the sliding restraint 128 is in the drop position.

It is to be appreciated by those skilled in the art that the Dropping Mechanism 100 can have alternative embodiments with only a mechanism housing aperture 113 or with only a base plate aperture 115. However, providing a Dropping Mechanism with both the base plate aperture 115 and the mechanism housing aperture 113 enables the Dropping Mechanism 100 to be flipped with respect to the drone 10 without obstructing the path of travel of the payload hook/payload strap 24 when the sliding restraint 128 is in the drop position.

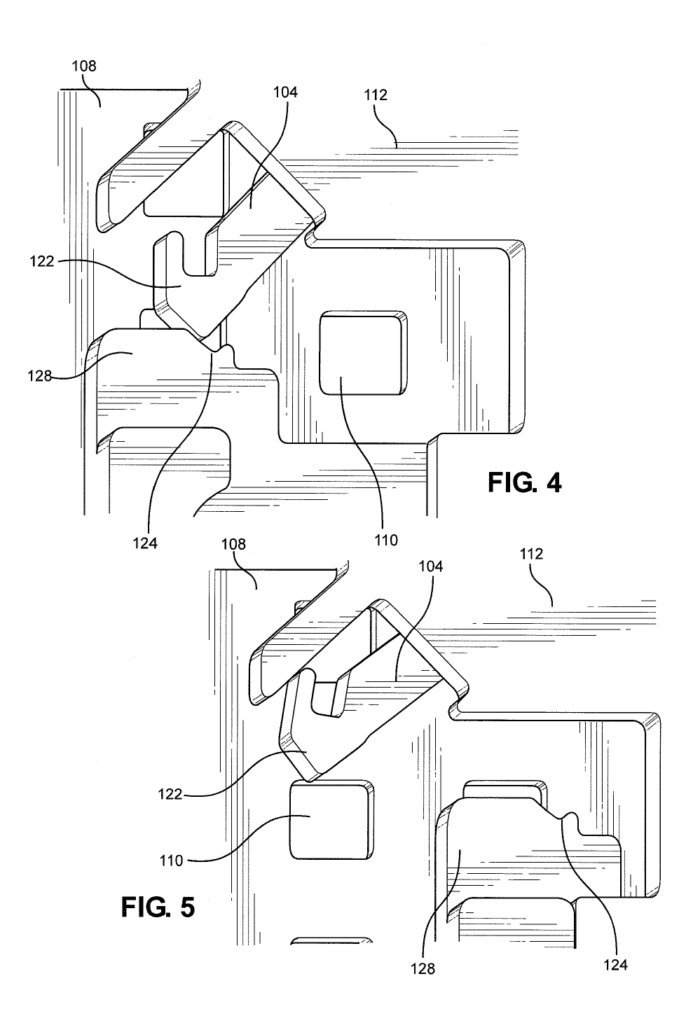

Referring now to FIG. 4 and FIG. 5, the connection between release trigger notch 122 and retention groove 124 in their secured and drop positions is shown respectively. As seen in FIG. 4, release trigger notch 122 sits in retention groove 124 with the elastic strap 118 in tension (not shown, see FIGS. 2 & 3) against an edge of release trigger notch 122. With release trigger notch 122 securing sliding restraint 128 in place, the Dropping Mechanism 100 is in its secured position. In FIG. 5, release trigger 104 has lifted release trigger notch 122 out of retention groove 124. As a result, sliding restraint 128 has been pulled back by elastic strap 118 (not shown, see FIGS. 2 & 3) putting the Dropping Mechanism 100 in its drop position.

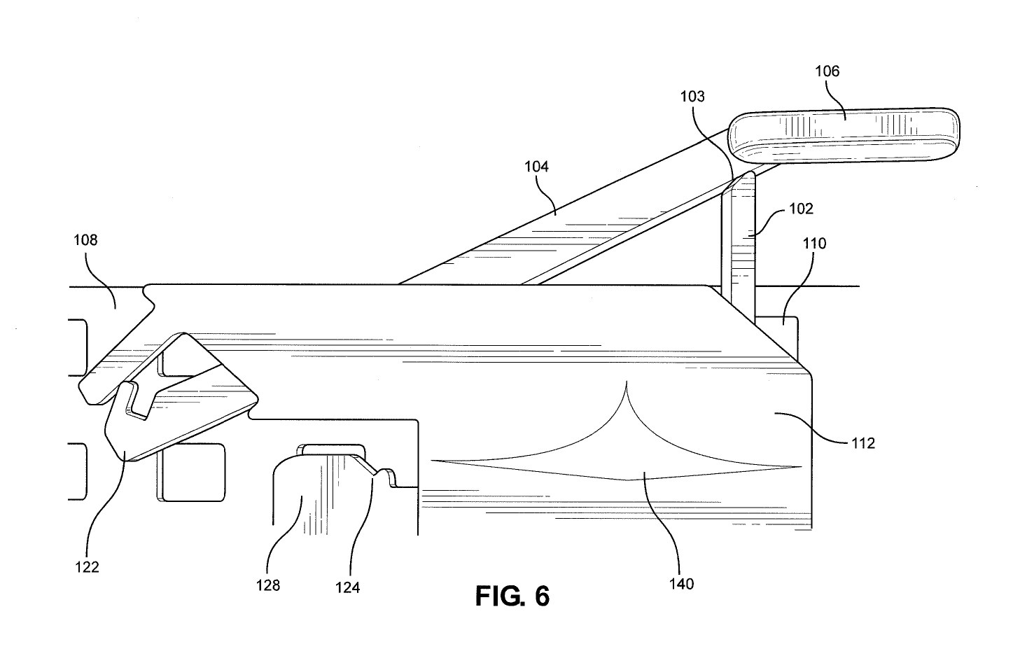

FIG. 6 shows the positioning of sliding restraint stop 102 and release trigger 104. When sliding restraint 128 is in the drop position, sliding restraint stop 102 is positioned under the edge of release trigger 104. When camera (not shown, see FIG. 1) pushes down on flat shoe 106 in direction 136, the release trigger 104 and the sliding restraint 128 move to the drop position. In the drop position, the release trigger 104 is stopped by sliding restraint stop 102 to prevent over travel of camera (not shown, see FIG. 1). When the sliding restraint 128 is secured, the angled surface 103 of sliding restraint stop 102 comes into contact with the angled body of release trigger 104 to prevent over travel of sliding restraint 128.

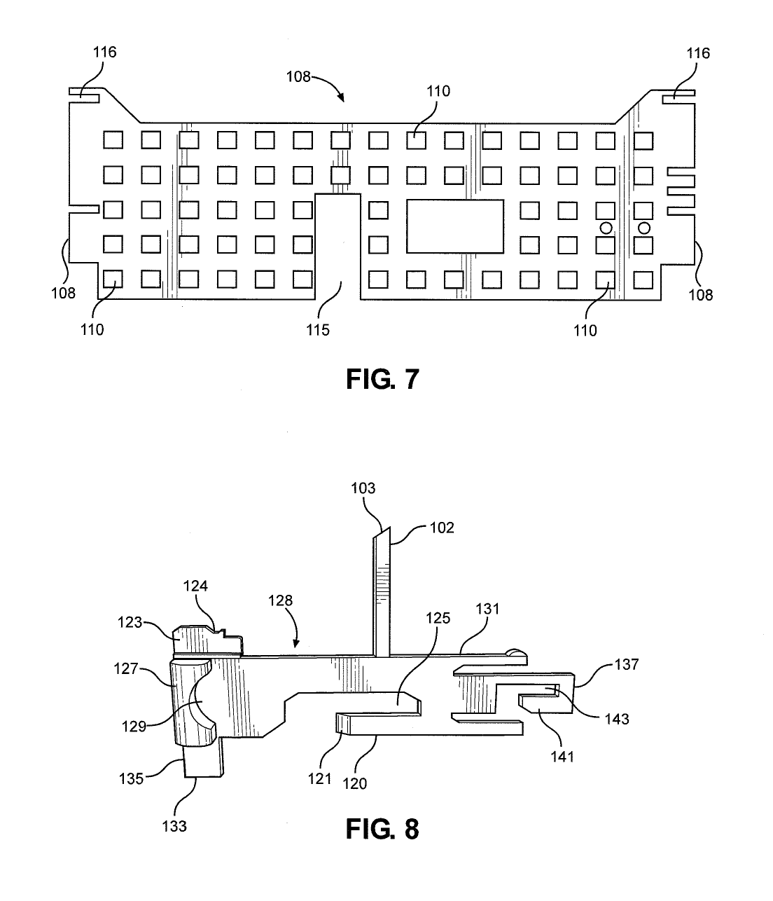

Referring now to FIG. 7, the base plate 108 is shown with attachment points 110 and mounting notches 116. In an embodiment, attachment points 110 are square and evenly spaced to allow accessories to be mounted in a plurality of configurations. However, any mounting method known by those skilled in the art that utilizes a square or through hole attachment point may be used including, but not limited to, tabbed inserts, pin assemblies, and bolts. Also, mounting notches 116 are shown in a configuration to mount to the drone landing gear 18 of a DJI® Phantom. It is known by those skilled in the art that the mounting notches 116 can be changed to different configurations that will allow the base plate 108 to be mounted to drone landing gear 18 of different types of drones. Multiple circular holes are cut into base plate 108, to allow different mounting configurations for tension screw 114. The base plate 108 has a base plate aperture 115 extending from a side of the base plate 108.

FIG. 8 shows the sliding restraint 128 having a sliding restraint top 131, a sliding restraint bottom 133, a stopper side 135 and a power side 137. A sliding restraint stop 102 is connected to and extends away from the sliding restraint top 131 of the sliding restraint 128. The sliding restraint stop 102 terminates in an angled surface 103.

The sliding restraint top 131 also has a retention tab 123 that is formed with a retention groove 124. The retention groove 124 is sized to receive and secure a release trigger notch 122 of a release trigger 104.

The sliding restraint bottom 133 is formed with a retaining pin 120 that terminates in a retaining pin sloped edge 121. The retaining pin 120 forms a retaining pin aperture 125 within the sliding restraint 128.

The stopper side 135 of the sliding restraint 128 has a stopper tab 127 with an access groove 129. The access groove 129 enables a user to pull the sliding restraint 128 from the drop position to the secure the position. The power side 137 of the sliding restraint 128 has a power side tab 141 that forms a power side aperture 143 in the sliding restraint 128. The elastic strap 118 (not shown) is held within the power side aperture 143.

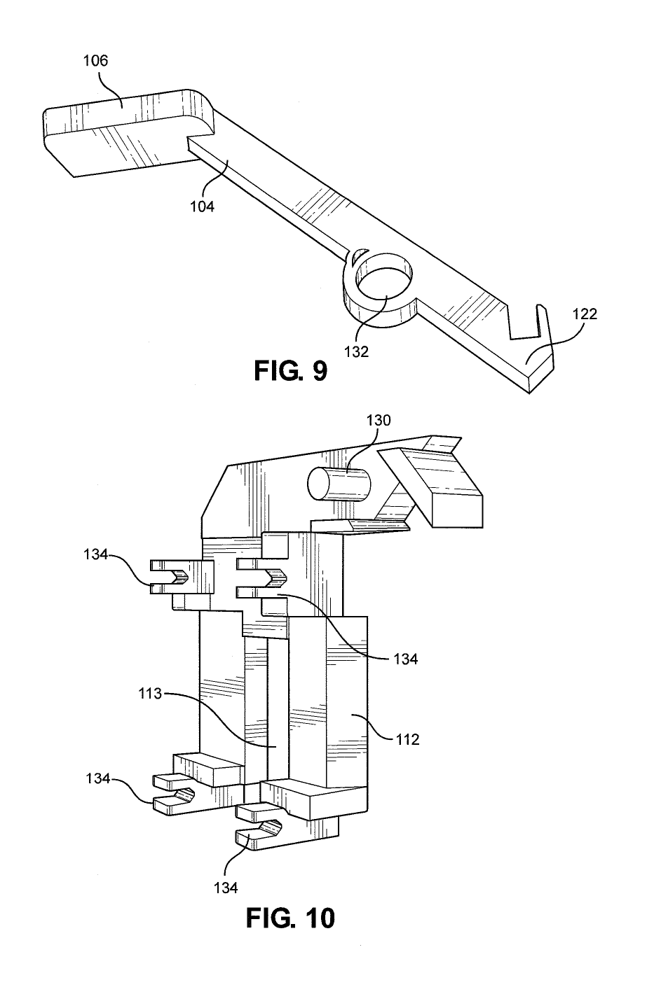

FIG. 9 shows the release trigger 104 with release trigger notch 122 opposite a flat shoe 106 and release trigger mounting hole 132. Release trigger notch 122 is formed in the shape of retention groove 124 in the sliding restraint 128 (not shown, see FIGS. 2-6, 8) to allow for increased surface to surface contact that will hold sliding restraint 128 (not shown, see FIGS. 2-6, 8) in place during use. Release trigger mounting hole 132 is rotatably secured to mechanism housing pin 130 (not shown, subsequently described in FIG. 10) to provide a pivot point for release trigger 104. When camera (not shown, see FIG. 1) hits the flat shoe 106 of the release trigger 104, the release trigger 104 pivots around mechanism housing pin 130 (not shown, subsequently described in FIG. 10), which lifts release trigger notch 122 out of retention groove 124 (not shown, see FIGS. 2-6, 8).

Referring now to FIG. 10, mechanism housing 112 is shown along with mechanism housing pin 130, mounting retaining clips 134 and mechanism housing aperture 113. Mechanism housing 112 retains release trigger (not shown, see FIGS. 2-6, and 9) and sliding restraint (not shown, see FIGS. 2-6 and 8) against base plate (not shown, see FIGS. 2-7). Mechanism housing 112 is connected to base plate 108 (not shown, see FIGS. 2-7) by securely inserting mounting retaining clips 134 into attachment points 110 of base plate 108 (not shown, see FIGS. 2-7). Mechanism housing pin 130 acts as a fulcrum for release trigger 104 (not shown, see FIGS. 2-6, and 9) when the camera 20 (not shown, see FIG. 1) strikes the flat shoe 106 of release trigger 104.

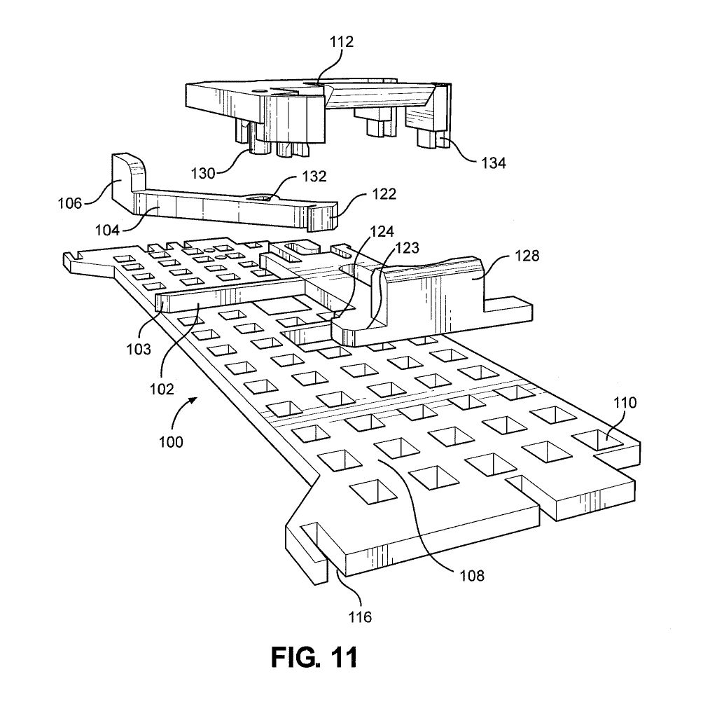

FIG. 11 is an exploded view of the Dropping Mechanism 100 of the present invention and shows sliding restraint stop 102, release trigger 104, base plate 108, attachment points 110, mechanism housing 112, mounting notch 116, release trigger notch 122, retention groove 124, release trigger mounting hole 132, mechanism housing pin 130, mounting retaining clip 134, and sliding restraint 128.

FIG. 11 shows how the mechanism housing pin 130 of mechanism housing 112 is inserted into release trigger mounting hole 132 of release trigger 104. Mechanism housing 112 and release trigger 104 are placed between sliding restraint stop 102 and retention groove 124 of sliding restraint 128. Mechanism housing 112 secures release trigger 104 and sliding restraint 128 to base plate 108 when mounting retaining clips 134 are inserted into attachment points 110.

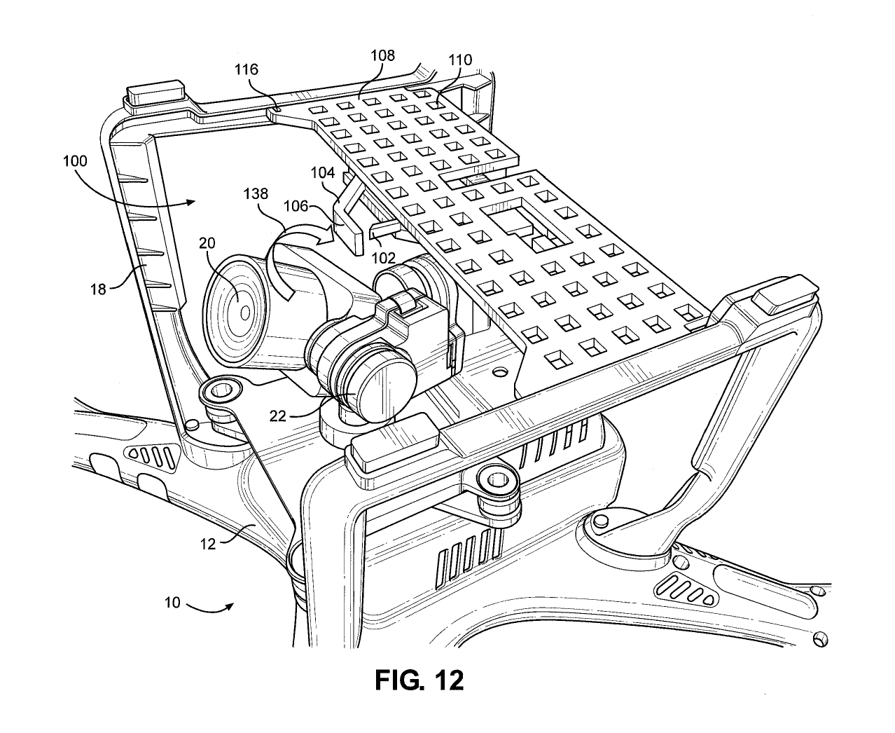

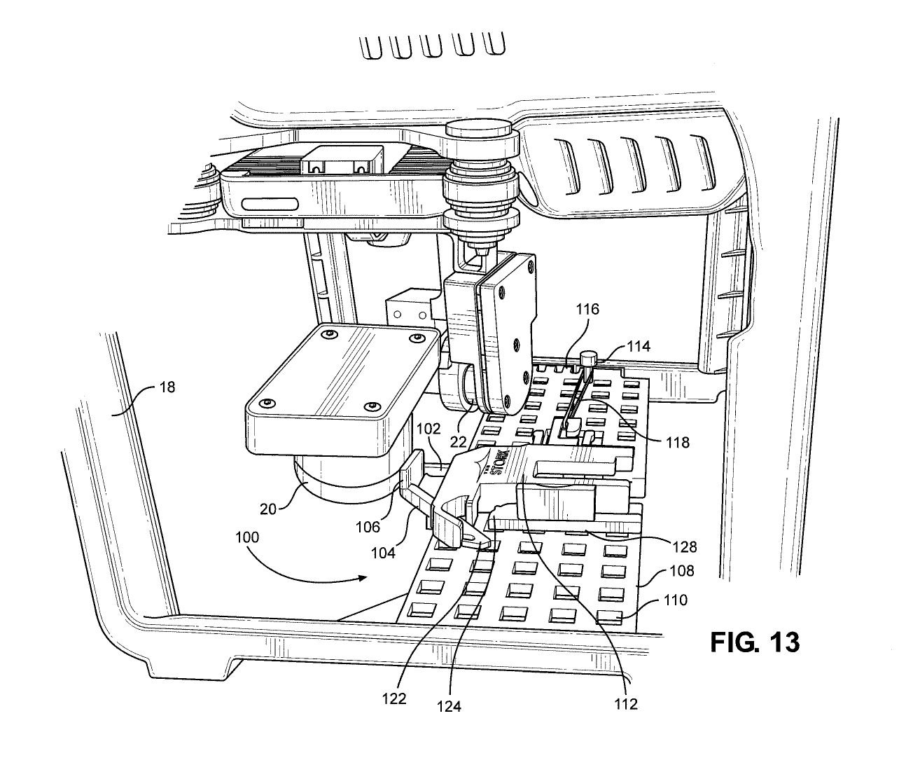

Referring now to FIG. 12 and FIG. 13, the Dropping Mechanism 100 of the present invention is attached to a drone 10 to show how the camera motors 22 can move camera 20 onto the flat shoe 106 of the release trigger 104 to release the sliding restraint 128 (not shown, see FIGS. 2-6,8 and 11). In FIG. 12, the Dropping Mechanism 100 is shown in the secured position. Mounting notches 116 are shown on the base plate 108 and connected to the landing gear 18 of the drone 10.

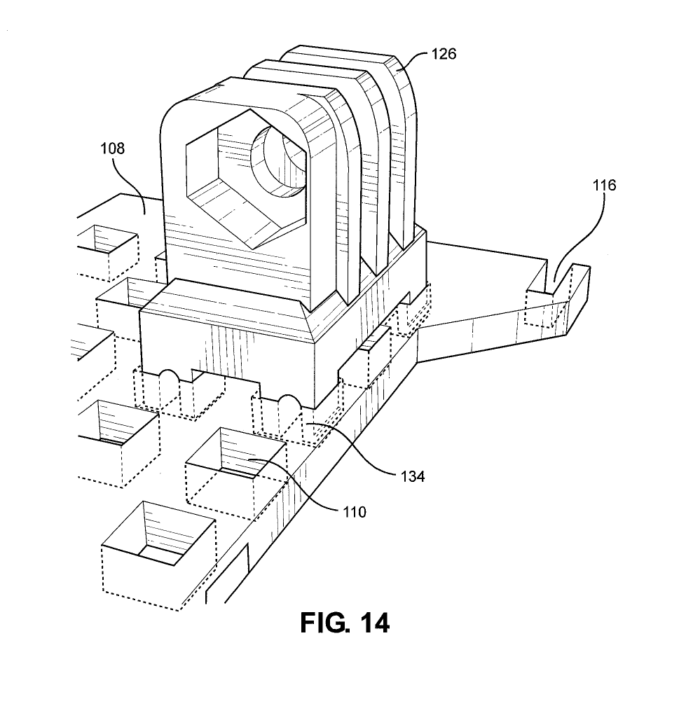

As the camera 20 is moved in direction 138 by camera motor 22, the camera 20 strikes the flat shoe 106 of the release trigger 104. In FIG. 13, the Dropping Mechanism 100 is shown having moved from the secured position to the drop position. As the release trigger 104 rotates, the release trigger notch 122 no longer is in contact and secured by retention groove 124 and the sliding restraint 128 is free to slide. The elastic strap 118 pulls on the sliding restraint 128 until the sliding restraint 128 slides sufficiently for the retaining pin 120 to be slid past the base plate aperture 115 and allow for the free fall of any object previously secured to the retaining pin 120 by way of the payload hook/payload strap 24 to fall free from the Dropping Mechanism 100. FIG. 14 shows a GoPro® mount 126 attached to base plate 108 with mounting retaining clips 134 inserted into attachment points 110. The orientation shown in FIG. 14 is only one of the plurality of orientations that GoPro® mount 126 could be attached to base plate 108 with mounting retaining clips 134.

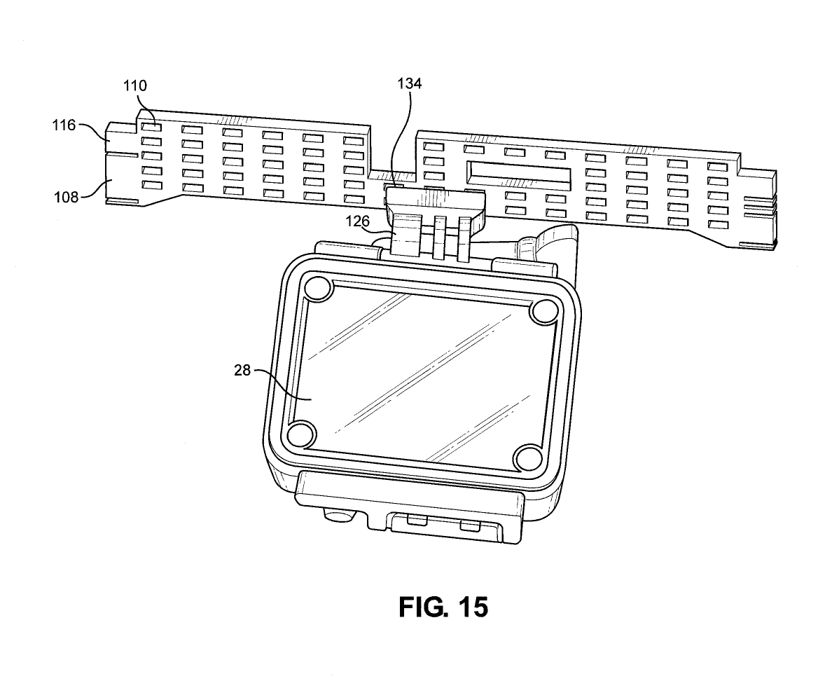

FIG. 15 shows a GoPro® camera 28 attached to the GoPro® mount 126 that is attached to base plate 108 with mounting retaining clips 134. The GoPro® camera 28 is shown connected to the underside of base plate 108 so that it does not interfere with the movement of the drone's camera (not shown, see FIGS. 1, 13, and 14).

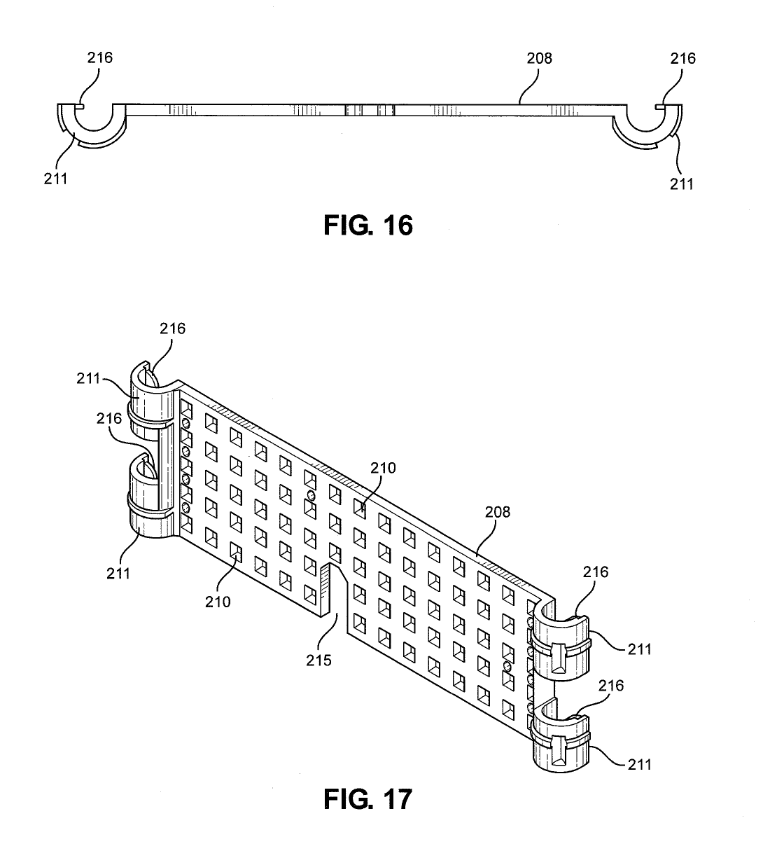

Referring now to FIGS. 16 and 17, an alternative embodiment of the base plate 208 of the Dropping mechanism 200 is shown. The base plate 208 has a plurality of attachment points 210 that are evenly spaced to allow for a wide variety of accessories to be mounted to the base plate 208. The base plate 208 is formed with end channels 211 that are sized to fit over the landing gear of a drone 10. The end channels 211 each have a retention notch 216 that is sufficiently flexible to enable the placement of a drone 10 landing gear in the end channel 211, but also stiff enough to retain the landing gear in the end channel 211. It is to be appreciated by those skilled in the art that other means are available to secure the landing gear to the end channel 211, such as clips, screws, or tape. The base plate is also formed with a base plate aperture 215.

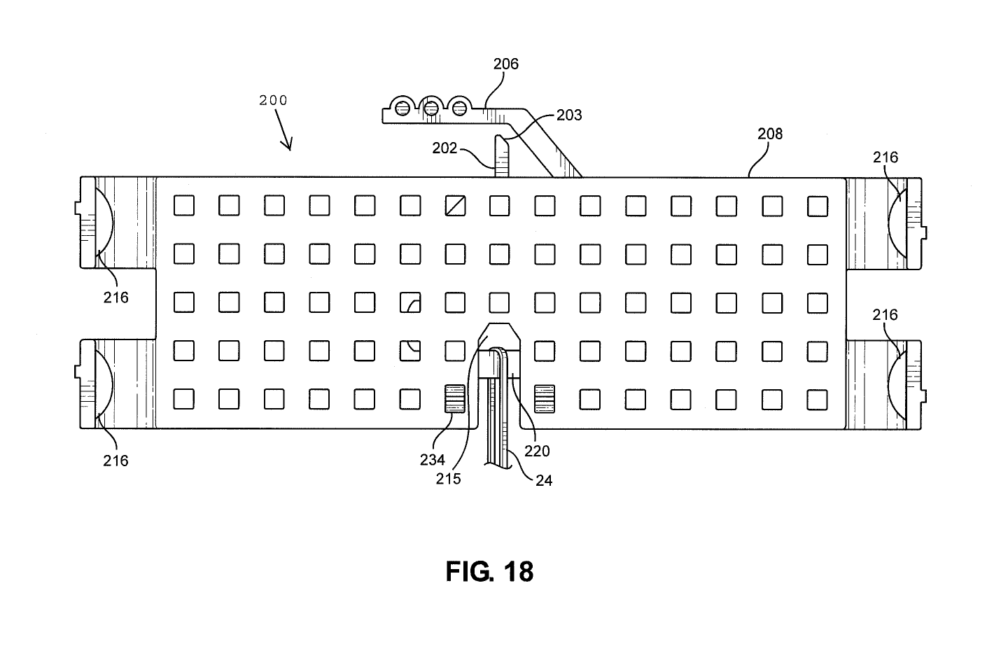

Referring now to FIGS. 18 through 20, an alternative embodiment of the Dropping mechanism 200 is shown equipped with the base plate 208 shown in FIGS. 16 and 17 and having an alternate energizing member made up of a spring 240 in lieu of the elastic strap 118. As with previous embodiments, the Dropping mechanism 200 has a sliding restraint 228 slidably disposed between a mechanism housing 212 and the base plate 208. The mechanism housing 208 has a mechanism housing aperture 213 generally corresponding in size to the base plate aperture 215. The mechanism housing 212 is connected to the base plate 208 such that the mechanism housing aperture 213 is generally aligned with the base plate aperture 215.

A release trigger 204 is rotatably connected to the mechanism housing 212 and acts to secure the sliding restraint 228 in the secured position. Similarly, when the release trigger 204 is actuated, the release trigger 204 releases the sliding restraint 228 to enable the sliding restraint 228 to slide from the secured position to the dropped position.

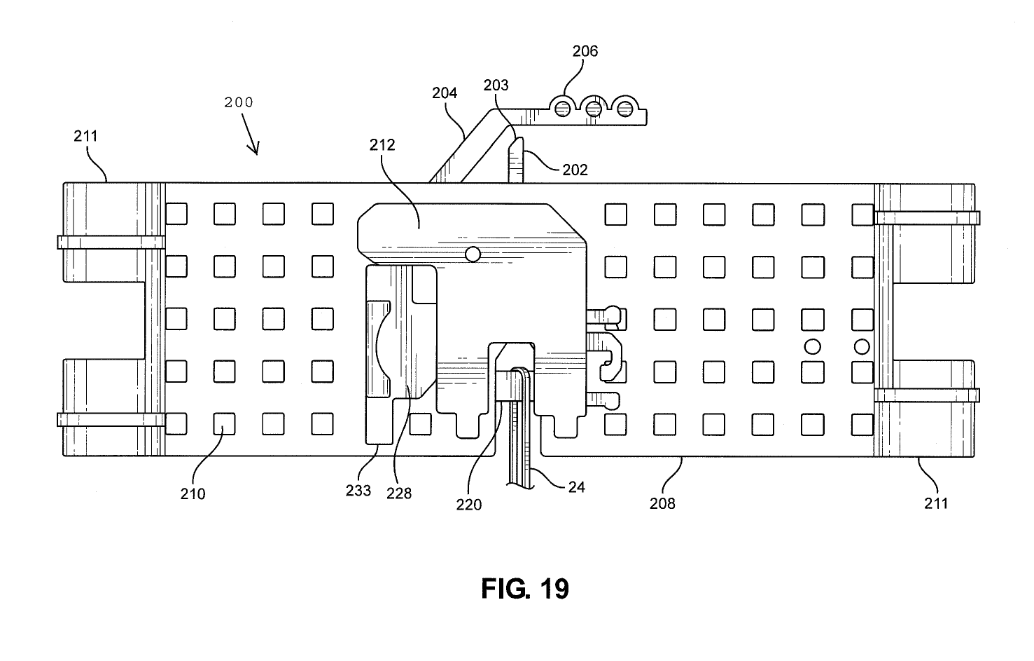

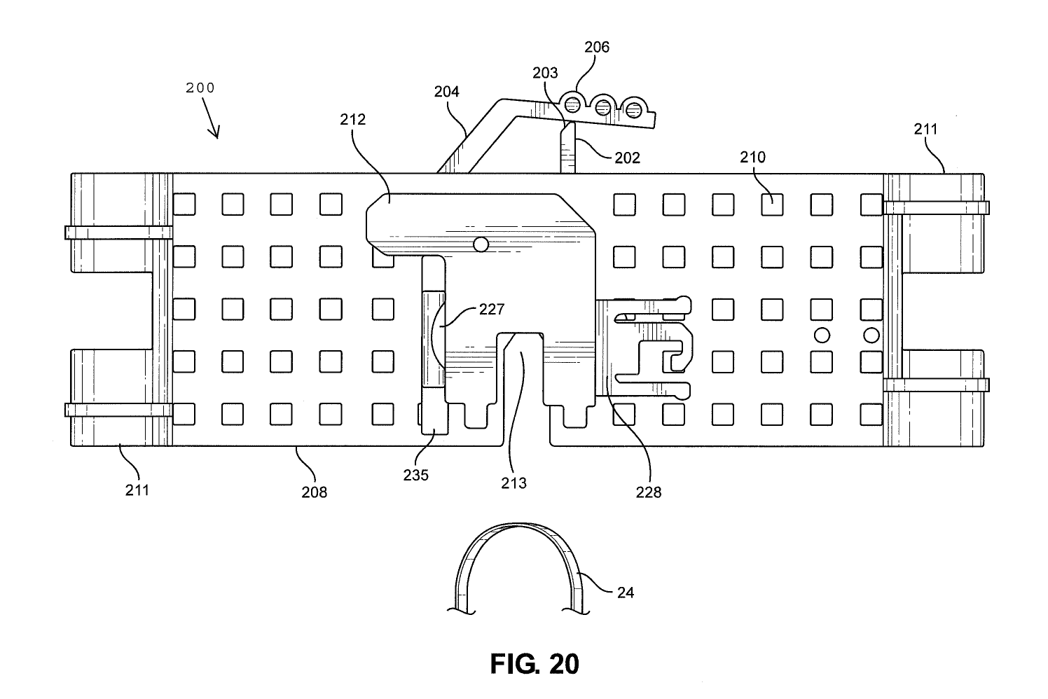

The sliding restraint 228 has a stopper side 235 with a stopper tab 227. The stopper tab 227 allows for easy hand manipulation to manually move the sliding restraint 228 from the drop position to the secured position by a user when setting up a new payload 26. The sliding restraint 228 also has a retaining pin 220 that traverses across the width of the base plate aperture 215 and the mechanism housing aperture 213 when in the secured position (shown in FIG. 19) and thereby acts to secure a payload hook 24 between the base plate aperture 215, the mechanism housing aperture 213 and the retaining pin 220. Similarly, when in the drop position (shown in FIG. 20), the retaining pin 220 slides behind the mechanism housing 212 thereby providing a clear path through both the base plate aperture 215 and the mechanism housing aperture 213 to ensure that the payload hook 24 and any payload 26 connected thereto has a clear path to drop from the Dropping mechanism 200.

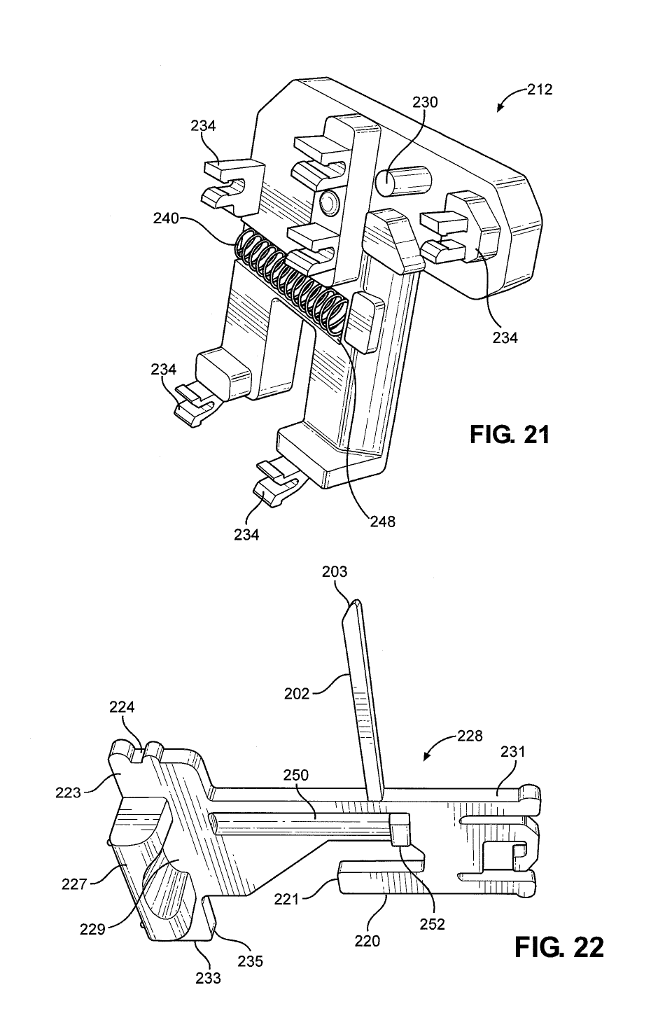

Referring now to FIG. 21, an alternative embodiment of the mechanism housing 212 (also shown in FIGS. 19 and 20) has a spring 240 partially housed within a first spring channel 248. The spring 240 is compressed when the sliding restraint 228 is put in the secured position, thereby becoming an energized member. A release trigger is rotatably connected to the mechanism housing 212 about a mechanism housing pin 230. When the release trigger 204 is actuated, it releases the sliding restraint 228. Once released, the spring force generated in the compressed spring 240 acts on the sliding restraint 228 thereby moving it from the secured position to the open position. The mechanism housing 212 is also equipped with mounting retaining clips 234 that are sized to fit and lock within corresponding attachment points 210 in the base plate 208.

Referring now to FIG. 22, the sliding restraint 228 is shown with a spring channel 250 sized to receive one half of the spring 240 not otherwise enclosed by the spring channel 248 of the mechanism housing 212. One end of the spring channel 250 has a spring compression tab 252. When the sliding restraint 228 is manually placed in the secured position, the spring compression tab 252 compresses the spring 240 thereby creating the energized member.

As with previous embodiments, the sliding restraint 228 has a retention tab 223 with a retention groove 224 sized to receive and secure a release trigger notch 222 of a release trigger 204. Also, as with previous embodiments, the sliding restraint 228 has a sliding restraint stop 202 extending away from the sliding restraint 228 and terminating in an angled surface 203.

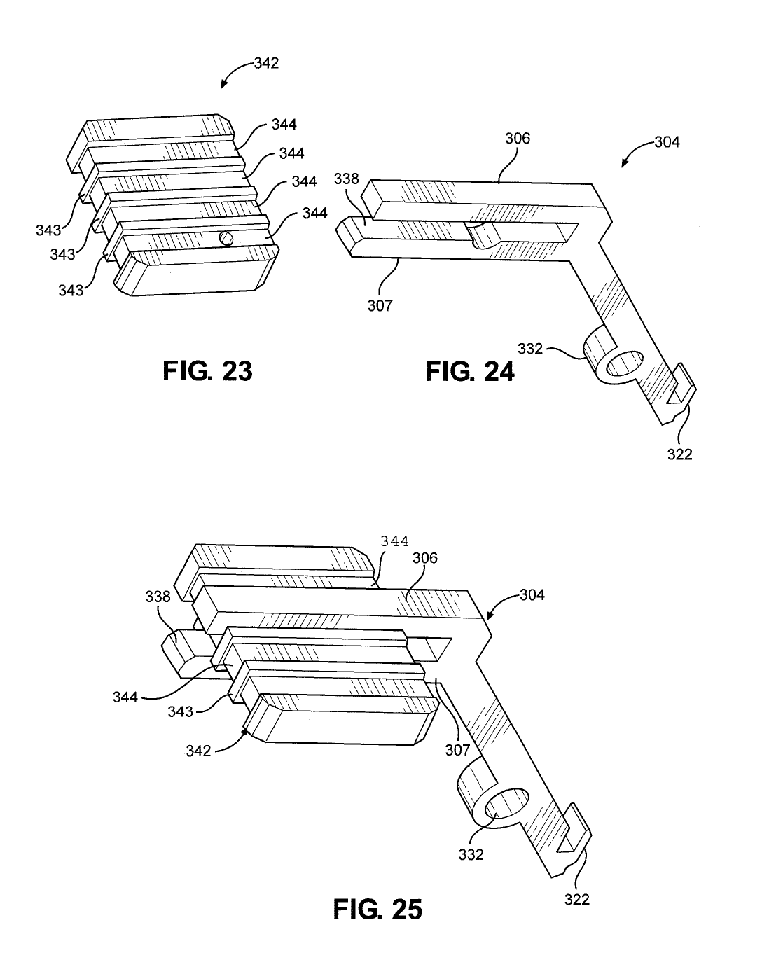

Referring now to FIGS. 23-25, an alternative forked release trigger 304 with a release trigger mounting hole 332 and a release trigger notch 322 similar to previous embodiments. However, in lieu of flat shoe 106, the forked release trigger 304 has first shoe 306 and a second shoe 307 forming a shoe slot 338 between the first shoe 306 and the second shoe 307. The first shoe 306 and second shoe 307 are sized to fit around and secure a strike plate extender 342 to the forked release trigger 304.

The strike plate extender 342 is fitted with a plurality of raised strike plate walls 343 separating a plurality of strike plate grooves 344 formed on opposing sides of the strike plate extender 342. The strike plate grooves 344 one side of the strike plate extender 342 are sized to slidably receive and secure the first shoe 306 while the remaining strike plate grooves 344 on the other side of the strike plate extender 342 are sized to slidably receive and secure the second shoe 307. The purpose of the strike plate extender 342 is to increase the surface area available for the camera 20 of the drone 10 to strike when actuating the release trigger 304. The plurality of strike plate grooves 344 provide the ability for a user to adjust the strike plate extender 342 for optimal placement to ensure that the camera 20 of the drone 10 will strike the release trigger 304 when the camera 20 is rotated by the user.

In use, a user first connects the Dropping mechanism 100 to the landing gear 18 of a drone 10. Next, the user connects a payload 26 to a payload hook or payload strap 24. The user then moves the sliding restraint 128 of the Dropping mechanism from a drop position to a secured position. As the user moves the sliding restraint 128 from the drop position to the secured position, the energizing member (the elastic strap 118, spring 240, or other energizing member known in the art) becomes energized. Also, as the user moves the sliding restraint 128 from the drop position to the secured position, the user simply passes the retaining pin 120 through the payload strap or payload hook 24 until the sliding restraint 128 is held in place by the release trigger notch 122 secured within the retention groove 124 in the sliding restraint 128. Once in the secured position, the payload strap or payload hook 24 are secured around the retaining pin 120 within the base plate aperture 115 and the mechanism housing aperture 113. Once so secured, the user flies the drone 10 to a desired altitude above a desired location. Finally, the user rotates the drone camera 20 towards the ground and in so doing, the camera 20 strikes the flat shoe 106 of the release trigger 104, thereby releasing the release trigger 104 from the sliding restraint 128. The sliding restraint 128 is then moved from the secured position to the drop position by the energized member (i.e., elastic strap 118, spring 240, etc) thereby enabling the payload hook or payload strap 24 to freely pass from the base plate aperture 115 and mechanism housing aperture 113, allowing the payload 26 to drop to the ground at the desired location. Finally, the user can view the payload 26 fall to the desired location using the camera 20 of the drone 10 to confirm that the payload 26 fell to the desired location.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

While there have been shown what are presently considered to be preferred embodiments of the present invention, it will be apparent to those skilled in the art that various changes and modifications can be made herein without departing from the scope and spirit of the invention. Accordingly, the invention is not to be limited as except by the appended claims.

1. A dropping mechanism comprising:
a base plate mounted to a landing gear of a drone;
a mechanism housing connected to the base plate;
a sliding restraint slidably disposed between the base plate and the mechanism housing such that the sliding restraint slides between a secured position and a drop position;
a release trigger rotatably connected to the mechanism housing and securing the sliding restraint in the secured position until the release trigger is actuated through contact with a camera rotatably connected to the drone; and
wherein the sliding restraint secures a payload when in the secured position.

2. The dropping mechanism of claim 1 wherein the base plate further comprises a plurality of attachment points.

3. The dropping mechanism of claim 2 wherein each of the attachment points is configured identically to one another and is equally spaced from one another.

4. The dropping mechanism of claim 1 wherein the release trigger further comprises a shoe opposite a release trigger notch.

5. The dropping mechanism of claim 4 wherein the sliding restraint further comprises a retention groove sized to receive and secure the release trigger notch of the release trigger when in the secured position.

6. The dropping mechanism of claim 1 wherein the sliding restraint further comprises a stopper side and a power side wherein the stopper side has a stopper tab and the power side has a power side tab forming a power side aperture.

7. The dropping mechanism of claim 6 wherein the sliding restraint further comprises a sliding restraint stop connected to and extending away from the sliding restraint and terminating in an angled surface.

8. The dropping mechanism of claim 1 further comprising an energized member capable of sliding the sliding restraint from the secured position to the drop position.

9. The dropping mechanism of claim 8 wherein the energized member is an elastic strap secured to the sliding restraint and secured to the base plate.

10. The dropping mechanism of claim 9 wherein the energized member is a spring.

11. The dropping mechanism of claim 1 further comprising a payload hook sized to be secured by the sliding restraint when in the secured position and wherein the payload is connected to the payload hook.

12. A dropping mechanism comprising:
a base plate mounted to a landing gear of a drone wherein the base plate includes a base plate aperture;
a mechanism housing with a mechanism housing aperture and connected to the base plate such that the mechanism housing aperture and the base plate aperture are aligned;
a sliding restraint slidably disposed between the base plate and the mechanism housing such that the sliding restraint slides between a secured position and a drop position and wherein the sliding restraint is formed with a retaining pin that spans a width of the mechanism housing aperture when in the secured position and clears the width of the mechanism housing aperture when in the drop position;
a release trigger rotatably connected to the mechanism housing and securing the sliding restraint in the secured position until the release trigger is actuated through contact with a camera rotatably connected to the drone;
an energized member connected to the sliding restraint and to the base plate wherein the energized member moves the sliding restraint from the secured position to the drop position upon actuation of the release trigger; and
wherein the retaining pin of the sliding restraint secures a payload hook in the base plate aperture and the mechanism housing aperture when in the secured position.

13. The dropping mechanism of claim 12 wherein the base plate further comprises a plurality of attachment points and the mechanism housing is connected to one or more of the attachment points by a plurality of mounting notches.

14. The dropping mechanism of claim 12 wherein the release trigger further comprises a shoe opposite a release trigger notch.

15. The dropping mechanism of claim 14 wherein the sliding restraint further comprises a retention groove sized to receive and secure the release trigger notch of the release trigger when in the secured position.

16. The dropping mechanism of claim 12 wherein the sliding restraint further comprises a stopper side and a power side wherein the stopper side has a stopper tab and the power side has a power side tab forming a power side aperture.

17. The dropping mechanism of claim 16 wherein the sliding restraint further comprises a sliding restraint stop connected to and extending away from the sliding restraint and terminating in an angled surface.

18. The dropping mechanism of claim 12 wherein the release trigger further comprises a forked shoe.

19. The dropping mechanism of claim 18 further comprising a strike plate extender having a plurality of grooves wherein the strike plate extender is slidably connected to the forked shoe at one of the plurality of grooves.

20. A method of dropping a payload from a drone comprising the steps of:
a. providing a drone with a landing gear and a camera rotatably connected to the drone;
b. connecting a dropping mechanism to the landing gear of the drone, the dropping mechanism comprising:
a base plate mounted to the landing gear of the drone;
a mechanism housing connected to the base plate;
a sliding restraint slidably disposed between the base plate and the mechanism housing such that the sliding restraint slides between a secured position and a drop position;
a release trigger rotatably connected to the mechanism housing and securing the sliding restraint in the secured position until the release trigger is actuated through contact with a camera rotatably connected to the drone; and
wherein the sliding restraint secures a payload when in the secured position;
c. securing a payload to a payload hook;
d. securing the payload hook to the dropping mechanism through the sliding restraint;
e. using the drone to lift the payload to a desired altitude above a desired location; and
f. rotating the camera until the camera strikes the release trigger and thereby releasing the payload hook and dropping the payload.
